(19) United States
(12) Patent Application Publication
(10) Pub. No.: US 2026/0225183 A1
(43) Pub. Date: Aug. 6, 2026

(54) LASER SCANNING HEAD FOR MARKING ITEMS

(71) Applicant: SIDEL PARTICIPATIONS, Octeville-sur-Mer (FR)

(72) Inventors: Guy FEUILLOLEY, OCTEVILLE- SUR-MER (FR); Véronique BERNARD, OCTEVILLE- SUR-MER (FR); Cyrille SAVARY, OCTEVILLE- SUR-MER (FR); Frédéric LECOMTE, OCTEVILLE- SUR-MER (FR); Daniel DIESNIS, OCTEVILLE- SUR-MER (FR); Guillaume CHAUVIN, OCTEVILLE- SUR-MER (FR)

(21) Appl. No.: 19/530,784

(22) Filed: Feb. 5, 2026

(30) Foreign Application Priority Data
Feb. 5, 2025 (FR) 2501195

(51) Int. Cl. B23K 26/082; B23K 26/352

(52) U.S. Cl. CPC B23K 26/0821; B23K 26/352

(57) ABSTRACT

Described is a laser scanning head for marking items, the scanning head having a housing including a laser entry window adapted to receive the laser beam emitted by a laser source, at least one galvanometric mirror mounted on the rotation shaft of a motor for rotating said galvanometric mirror, and an exit window through which the marking laser beam is emitted towards an item. The housing includes two opposite exit windows and means for emitting two marking laser beams emitted through the exit windows from the laser beam emitted by the laser source passing through the entry window.

### CROSS-REFERENCE TO RELATED APPLICATIONS

This application claims the benefit of French Application No. FR2501195, filed Feb. 5, 2025, the entire contents of which is hereby incorporated herein by reference.

### Technical field

The present disclosure relates to the field of marking items, such as containers, in particular bottles or jars, produced by blow moulding or stretch blow moulding from parisons made of plastic such as polyethylene terephthalate (PET) and/or recycled polyethylene terephthalate (rPET) and, more specifically, to a laser scanning head for marking such items.

### Background

In the field of production of containers made of PET, such as bottles, it is well known practice to include on said containers information such as the capacity, the composition of the contents of the containers, the expiry date, etc. and/or decoration such as the logo of the manufacturer of the product, for example.

Usually, this information appears on labels made of paper or plastic which are stuck onto the final container after the step of forming the container, or after the step of filling the container, in other words when the containers are in their definitive shape.

However, labelling containers has many disadvantages. To be specific, the production of labels, printing these labels and sticking them on the containers represents a significant cost, in particular as regards the mass production of containers. Furthermore, the label is liable to be torn off during handling of the container, and the end user may not then have access to some important pieces of information, such as the expiry date. Lastly, the recycling of containers made of PET is made more difficult by the presence of the label and the adhesive, as these constitute impurities that make the containers opaque and negatively affect their mechanical properties, in the case of containers made of recycled PET (rPET).

For the inscription of important information, methods for marking the wall of the container have already been proposed. It is thus known practice to print certain important information directly on the wall of the container using a special ink.

Nevertheless, this method of marking by printing is not satisfactory because, for hygiene reasons, the ink used for marking must dry almost instantaneously and it must also remain on the surface of the wall without migrating into the container. Therefore, the ink has a specific composition which is very expensive to produce.

Furthermore, the use of ink also makes the recycling of plastic containers more difficult.

To overcome these problems, a method of marking by etching the wall of the container has also been proposed. Etching is generally carried out using a carbon dioxide laser. Such a marking method is performed by removing material from the wall of the container, in particular by evaporation. As a result, the wall locally has a reduced thickness.

However, with a view to making packaging more environmentally friendly and less expensive, there is a tendency towards reducing the thickness of the wall of containers. It is thus possible to produce a container using less plastic than before. However, removing material from a very thin wall poses the risk of weakening the wall to the extent that the container will rupture when the slightest stress is applied.

Other known laser marking devices pose problems in terms of quality with respect to components or substrates which are not flat and/or which have a variable focal distance from the optics, as is the case with most containers.

In such cases, the marks made on the substrate are blurred, vary in terms of height or spacing and may be otherwise illegible, thus making the characters unsatisfactory for use.

To overcome this problem, it is often necessary to stop the container to be marked from moving, which has a direct impact on the throughput of the production line.

In this regard, laser marking facilities for marking thermoplastic containers produced by stretch blow moulding, in particular bottles or vials, have already been designed. See, in particular, documents EP2380693, EP2983106, FR2907370 and CN116275544.

EP2380693 describes a system for marking a moving object, such as a container, by means of a laser which comprises a laser system with a laser beam with the ability to mark within a working area, with a controller, a drive system with the ability to move the object to be marked, with a speed controller, and a sensor system for obtaining the position of the object to be marked, the laser system and the sensor system being connected in such a way that the controller of the laser system has one signal input corresponding to a position signal from the sensor system. The laser system and the drive system are connected in such a way that the speed controller of the drive system receives a speed variation signal from the controller of the laser system, which is a function of the position signal received by the laser system in relation to the working area and the position of the laser beam inside the working area.

EP2983106 describes a method and system for printing information on a container. The method consists in providing a printing system having a laser source for producing a printing beam and directing the beam to a plurality of locations on a material, and/or adjusting a dwell time of the printing beam in at least one location so as to form a spot at each location. The method may also consist in providing a printing system for printing a code on a product moving in a direction, and/or printing the code according to a corrected data set. The system includes a laser configured to produce a printing beam, the laser being at most a 25 watt laser, and a housing including a printing beam exit member through which said printing beam exits the housing. The system lastly includes, within the housing, an optics assembly that focuses the printing beam on a product that is adjacent to the housing.

FR2907370 describes a facility for marking, at the exit of a forming machine, transparent or translucent objects moving in translation, in succession, in front of a marking station that comprises a device for producing a laser beam to ensure marking of the objects. Said facility comprises means for determining the position of each of the objects in at least one direction transverse to the direction of movement of the objects, these means being placed upstream of the marking station relative to the direction of movement, means for shifting the focusing plane of the laser beam, in a transverse direction relative to the direction of movement, means for controlling the shifting means, connected to the determining means, and making it possible to adjust, as a function of the position of each object to be marked, the focusing plane of the laser beam in order to optimize the marking of the objects by the laser beam.

CN116275544 describes a batch laser marking system for marking the bodies of plastic bottles, which includes a first screw conveyor, a first bottle-gripping and-conveying device, a first finished product conveyor, and an array of flying laser marking devices. The array of flying laser marking devices includes several flying laser marking devices, with a laser marking station arranged in front of a laser scanning head of each flying laser marking device, and the first bottle-gripping and-conveying device takes hold of the mouths of the plastic bottles arranged equidistantly and conveys the bottle mouths to the corresponding laser marking stations of the array of flying laser marking devices. The array of flying laser marking devices laser-marks a pattern on the bodies of the plastic bottles arranged equidistantly, and the first bottle-gripping and-conveying device takes hold of the laser-marked plastic bottle bodies and conveys them to the first finished product conveyor so that they can be taken to the next production station.

However, all of these devices for laser marking on plastic containers have the drawback that they do not allow containers to be marked at a high rate, in other words at a rate of over 4000 bottles per hour. It is to the provision of a meeting these and other needs that the present invention is primarily directed.

### SUMMARY

Embodiments of the present disclosure provide for laser scanning heads for marking items and facilities for marking containers, the facilties including the laser scanning heads.

An embodiment of the present disclosure includes a laser scanning head for marking items. The scanning head can include a housing, the housing having a laser entry window adapted to receive a marking laser beam emitted by a laser source, at least one galvanometric mirror mounted on a rotation shaft of a motor for rotating said galvanometric mirror, and an exit window through which the marking laser beam is emitted towards an item. The housing can include two opposite exit windows. The scanning head can be configured to emit two marking laser beams emitted through the exit window from the laser beam emitted by the laser source passing through the entry window.

An embodiment of the present disclosure also includes a facility for marking containers. The facility can include at least two conveyors and a plurality of marking devices configured to insert information in at least one information region of a container. Each marking device can be positioned between the two conveyors and configured to alternately insert information in the laser marking region of a first container on a first conveyor then in the information region of a second container on the second conveyor. The marking devices are configured to emit laser radiation in two opposite directions, the marking devices located in fixed positions equidistant from the two conveyors. Each marking device can include a laser scanning head for marking items. The scanning head can have a housing, the housing including a laser entry window adapted to receive a marking laser beam emitted by a laser source, at least one galvanometric mirror mounted on a rotation shaft of a motor for rotating said galvanometric mirror, and an exit window through which the marking laser beam is emitted towards an item. The housing can include two opposite exit windows. The scanning head can be configured to emit two marking laser beams emitted through the exit window from the laser beam emitted by the laser source passing through the entry window

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

Further advantages and features will become more clearly apparent from the following description of a number of alternative embodiments, provided by way of non-limiting examples, of the laser scanning head for marking items in accordance with the disclosure, with reference to the appended drawings in which:

FIG. 1 is a schematic top view of a marking facility including a laser scanning head according to the disclosure,

FIG. 2 is a schematic top view of the marking facility according to the disclosure in a second step of the marking method,

FIG. 3 is a schematic top view of the marking facility according to the disclosure in a third step of the marking method,

FIG. 4 is a schematic top view of the marking facility according to the disclosure in a fourth and final step of the marking method,

FIG. 5 schematically depicts, in a perspective line drawing, the laser scanning head according to the disclosure,

FIG. 6 schematically depicts, in a perspective line drawing, an alternative embodiment of the laser scanning head according to the disclosure,

FIG. 7 is a schematic front view of a container, showing in particular two laser marking areas.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

It is therefore one of the aims of the disclosure to overcome all or some of these drawbacks by proposing a laser scanning head for marking items, in particular plastic containers, which has a simple design and is inexpensive and makes it possible to print information on the items at a high rate.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

To this end, and in accordance with the disclosure, there is proposed a laser scanning head for marking items, said scanning head being at least composed of a housing including a laser entry window adapted to receive the laser beam emitted by a laser source, at least one galvanometric mirror mounted on the rotation shaft of a motor for rotating said galvanometric mirror, and an exit window through which the marking laser beam is emitted towards an item; said laser scanning head is remarkable in that said housing includes two opposite exit windows and means for emitting two marking laser beams emitted through the exit windows from the laser beam emitted by the laser source passing through the entry window. The means for emitting laser beams can include such as galvanometric mirrors, electric motors, and combinations thereof.

According to a first embodiment, said means for emitting two laser beams are adapted to simultaneously emit two marking laser beams through the two exit windows.

According to a preferred second embodiment, said means for emitting two laser beams are adapted to emit a marking laser beam alternately through a first exit window and a second exit window.

Preferably, the housing of each laser scanning head is substantially parallelepiped, one of the walls including the entry window and two other opposite walls respectively including an exit window.

Moreover, the entry window is formed on the upper wall of the parallelepiped housing and the exit windows are formed on two opposite side walls of said housing.

Each scanning head includes a first galvanometric mirror extending in line with the entry window and rigidly secured to the output shaft of a first electric motor, said first galvanometric mirror being adapted to reflect the laser beam passing through the entry window towards a second galvanometric mirror referred to as the distributor galvanometric mirror, extending in line with the exit windows and rigidly secured to the output shaft of a second electric motor, the output shaft of the second electric motor being orthogonal to the output shaft of the first electric motor.

Alternatively, each scanning head includes a first galvanometric mirror extending in line with the entry window and rigidly secured to the output shaft of a first electric motor, said first galvanometric mirror being adapted to reflect the laser beam passing through the entry window towards a second galvanometric mirror referred to as the distributor galvanometric mirror and rigidly secured to the output shaft of a second electric motor, the output shaft of the second electric motor being orthogonal to the output shaft of the first electric motor, said second distributor galvanometric mirror reflecting the laser beam alternately on to a third and a fourth galvanometric mirror extending respectively in line with the exit windows, the third and the fourth galvanometric mirror being rigidly secured to the output shaft of a third electric motor and a fourth electric motor, respectively.

Preferably, the output shafts of the second electric motor, of the third electric motor and of the fourth electric motor extend parallel to one another.

Moreover, each of the exit windows is equipped with a lens. cl EXAMPLES

In the remainder of the description, elements having an identical structure or similar functions will be designated using the same reference sign.

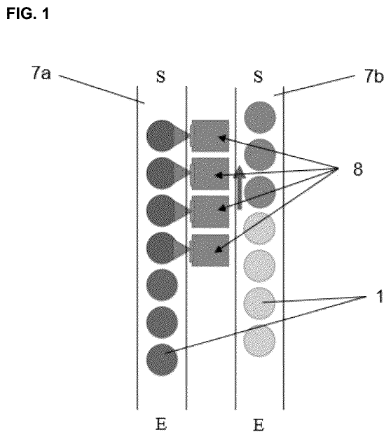

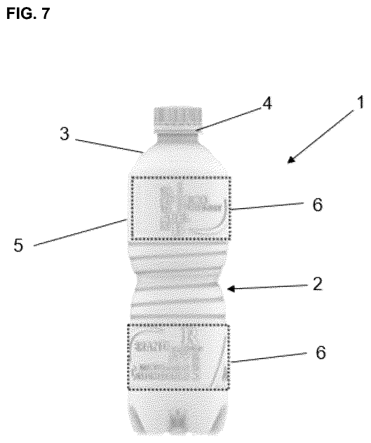

With reference to FIG. 1, a facility for marking containers 1 made of thermoplastic, obtained by a stretch blow moulding process, in particular bottles or vials, from a preform made of plastic such as polyethylene terephthalate (PET) and/or recycled polyethylene terephthalate (rPET) or the like, will be described, said container 1 including, with reference to FIG. 7, at least a body 2, a shoulder 3 in the extension of said body 2, at an upper end thereof, a neck 4 in the extension of the shoulder 3, said neck receiving a stopper, and a wall 5, said wall comprising two regions referred to as information regions 6.

In this particular example, said wall 5 includes two information regions. However, it is obvious that said wall 5 of the container 1 could have only a single information region 6 or more than two information regions 6 without thereby departing from the scope of the disclosure.

Furthermore, it goes without saying that the container 1 could be replaced by any other item without thereby departing from the scope of the disclosure.

Moreover, with reference to FIG. 1, said facility comprises at least two conveyors 7a, 7b adapted to take said containers 1 along two separate circulation paths on two separate packaging lines, from an inlet (E) to an outlet(S) of each conveyor 7a, 7b, and a plurality of laser marking devices 8 adapted to insert information in said at least one information region 6 of the containers 1, referred to as a laser marking region of a container, each marking device being positioned between the two conveyors 7a, 7b and being adapted to alternately insert information in the laser marking region of a container 1 on a first conveyor 7a then in the laser marking region of a container on the second conveyor 7b. Each conveyor 7a, 7b consists of a stepper motor belt conveyor.

Naturally, the belt conveyors 7a, 7b could be replaced by any other equivalent conveyor device, such as a gripper conveyor that takes hold of the containers 1 by the neck or the like, which is well known to those skilled in the art, without thereby departing from the scope of the disclosure.

Said conveyors 7a, 7b respectively include a device for spacing apart the containers 1 so that each container takes up a position facing each of the laser marking devices 8.

Moreover, said two conveyors 7a, 7b are positioned parallel to one another such that the circulation paths of the containers 1 on said conveyors 7a, 7b travel in the same direction. The interval of each belt conveyor 7a, 7b is substantially equal to the distance separating four containers 1 carried by said conveyor 7a, 7b. As will be described in detail further below, the first belt conveyor 7a is moved by one interval while the second belt conveyor 7b is stationary, and vice versa.

Advantageously, said conveyors 7a, 7b could include a device for adjusting their position relative to the laser marking devices 8 in order to have the containers 1 at the desired focal distance. To be specific, in the case where the same facility could be used for marking containers of different diameters, it could be necessary to adjust this focal distance between each production run.

Moreover, in this particular example of an embodiment, said facility includes four marking devices 8 including means for emitting laser radiation in two opposite directions, said marking devices 8 being in fixed positions equidistant from the two conveyors 7a, 7b, i.e. along a median line parallel to the circulation paths of the conveyors 7a, 7b, said marking devices 8 being described in detail below. Said marking devices 8 are positioned on said median line equidistant from one another with substantially the same distance separating the containers 1 carried by the conveyors 7a, 7b.

It will be appreciated that the facility could include more or fewer than four marking devices 8 without thereby departing from the scope of the disclosure. However, note that high production rates may be obtained using only four marking devices 8.

Thus, with reference to FIG. 1, four containers 1 on a first conveyor 7a are positioned in line with the four marking devices 8 of the facility, each laser marking device 8 then applying a mark in what are referred to as the information region or regions 6 of each container 1 on the first conveyor 7a for a duration of around 3 seconds, the laser marking beam from said marking devices 8 being oriented towards said first conveyor 7a.

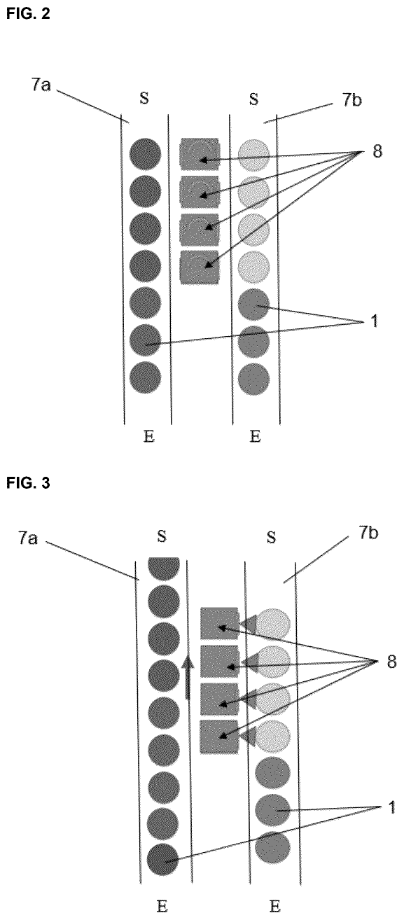

After this operation of marking the containers 1 on the first conveyor 7a, with reference to FIG. 2, the direction of marking of the marking devices 8 is changed such that the laser marking beam from the marking devices 8 is oriented in the opposite direction, in other words towards the second conveyor 7b on which the containers 1 extend in line with said marking devices 8. The time required to change the marking direction of the marking devices 8 is around 0.1 second.

With reference to FIG. 3, the four containers 1 on the second conveyor 7b being positioned in line with the four marking devices 8 of the facility, each laser marking device 8 then applies a mark in what are referred to as the information region or regions 6 of each container 1 on the second conveyor 7b for a duration of around 3 seconds, the laser marking beam from said marking devices 8 being oriented towards said second conveyor 7b. At the same time, the first conveyor 7a is actuated by one interval in order to carry the four marked containers 1 out of the marking area of the marking devices 8 and to position four new containers 1 on the first conveyor 7a in line with the marking devices 8.

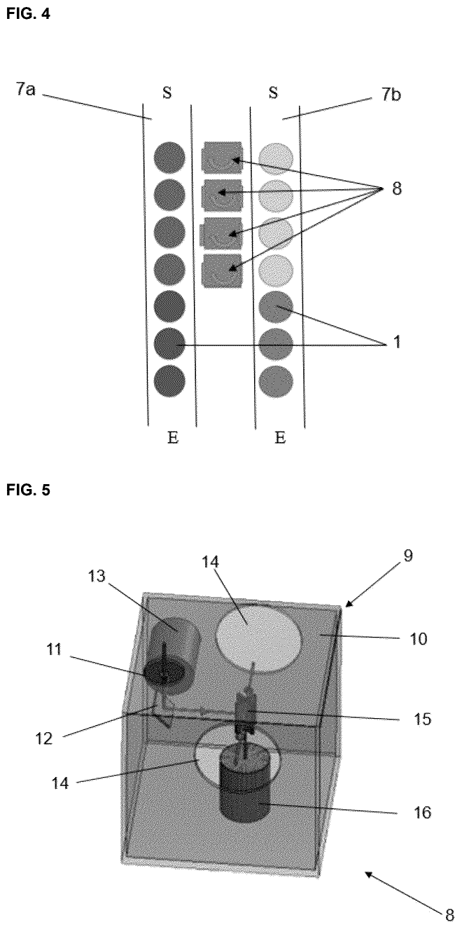

After this operation of marking the containers 1 on the second conveyor 7b, with reference to FIG. 4, the direction of marking of the marking devices 8 is changed such that the laser marking beam from the marking devices 8 is oriented in the opposite direction, in other words again towards the first conveyor 7a on which the containers 1 extend in line with said marking devices 8. The time required to change the marking direction of the marking devices 8 is also around 0.1 second.

The containers 1 on the first conveyor 7a are then marked by the marking devices 8, with reference to FIG. 1, while the marked containers 1 on the second conveyor 7b are moved by actuating said second conveyor 7b by one interval for a new cycle, the duration of a cycle being of the order of 6.2 seconds such that the facility according to the disclosure makes it possible to mark around 4600 containers per hour.

According to a second embodiment, with reference to FIG. 5, each marking device includes at least one laser source, not shown in FIG. 5, and a laser scanning head 9 composed of a housing 10 including, on its upper face, a laser entry window 11 adapted to receive the laser beam emitted by the laser source, at least a first galvanometric mirror 12 mounted on the rotation shaft of a first motor 13 for rotating said galvanometric mirror 12 and two opposite exit windows 14 through which the laser marking beam is emitted alternately through a first exit window 14 and a second exit window 14.

Said housing 10 of each laser scanning head 9 is substantially parallelepiped, one of the walls, in this instance the upper wall of the housing 10, including the entry window 11, and two other walls, in this instance two opposite side walls, respectively including an exit window 14. Note that the exit windows 14 could include a lens, not shown in FIG. 5.

Moreover, each scanning head 9 includes a first galvanometric mirror 12 extending in line with the entry window 11 and rigidly secured to the output shaft of a first electric motor 13, said first galvanometric mirror 12 being adapted to reflect the laser beam passing through the entry window 11 towards a second galvanometric mirror 15 referred to as the distributor galvanometric mirror, extending in line with the exit windows 14 and rigidly secured to the output shaft of a second electric motor 16, the output shaft of the second electric motor 16 being orthogonal to the output shaft of the first electric motor 13 which extends substantially horizontally.

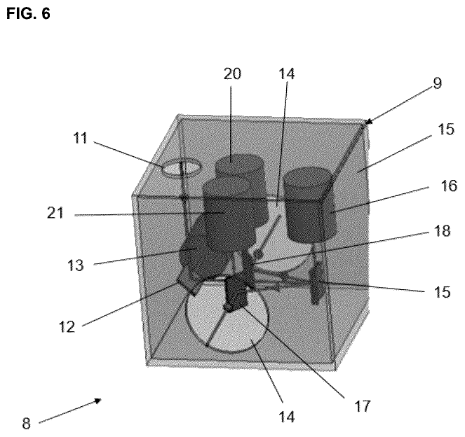

According to a second embodiment, with reference to FIG. 6, each scanning head 9 includes, as previously, at least one laser source, not shown in FIG. 6, and a laser scanning head 9 composed of a housing 10 including, on its upper face, a laser entry window 11 adapted to receive the laser beam emitted by the laser source, at least a first galvanometric mirror 12 mounted on the rotation shaft of a first motor 13 for rotating said galvanometric mirror 12, and two opposite exit windows 14 through which the laser marking beam is emitted alternately through a first exit window 14 and a second exit window 14.

Said housing 10 of each laser scanning head 9 is substantially parallelepiped, one of the walls, in this instance the upper wall of the housing 10, including the entry window 11, and two other walls, in this instance two opposite side walls, respectively including an exit window 14. Note that the exit windows 14 could include a lens, not shown in FIG. 5.

Each scanning head 9 includes a first galvanometric mirror 12 extending in line with the entry window 11 and rigidly secured to the output shaft of a first electric motor 13, said first galvanometric mirror 12 being adapted to reflect the laser beam passing through the entry window 11 towards a second galvanometric mirror 15, referred to as the distributor galvanometric mirror and rigidly secured to the output shaft of a second electric motor 16, the output shaft of the second electric motor 16 being orthogonal to the output shaft of the first electric motor 13 which extends substantially horizontally, said second distributor galvanometric mirror 15 reflecting the laser beam alternately on to a third 17 and a fourth 18 galvanometric mirror extending respectively in line with the exit windows 14, the third 17 and the fourth 18 galvanometric mirror being rigidly secured to the output shaft of a third electric motor 19 and a fourth electric motor 20, respectively. The output shafts of the second electric motor 16, of the third electric motor 19 and of the fourth electric motor 20 extend parallel to one another and vertically and make it possible to emit a laser marking beam alternately through the exit windows 14.

It goes without saying that the combinations of galvanometric mirrors and electric motors described above could be replaced by any other means for emitting two laser beams adapted to emit, alternately or simultaneously, two laser marking beams through the two exit windows 14 of the laser scanning head 9 according to the disclosure, without thereby departing from the scope of the disclosure.

Lastly, naturally, the examples just provided merely constitute particular illustrations of and are in no way limiting on the fields of application of the disclosure.

1. A laser scanning head for marking items, the scanning head at least comprising a housing, the housing comprising a laser entry window adapted to receive a marking laser beam emitted by a laser source, at least one galvanometric mirror mounted on a rotation shaft of a motor for rotating the galvanometric mirror, and an exit window through which the marking laser beam is emitted towards an item, wherein the housing comprises two opposite exit windows, the scanning head configured to emit two marking laser beams emitted through the exit window from the laser beam emitted by the laser source passing through the entry window.

2. The laser scanning head for marking items according to claim 1, wherein the scanning head is configured to simultaneously emit two marking laser beams through the two exit windows.

3. The laser scanning head for marking items according to claim 1, wherein the scanning head is configured to emit a marking laser beam alternately through a first exit window and a second exit window.

4. The laser scanning head for marking items according to claim 3, wherein the housing of the laser scanning head is substantially parallelepiped, having one wall comprising the entry window and two other opposite walls respectively including one of the exit windows.

5. The laser scanning head for marking items according to claim 4, wherein the entry window is formed on an upper wall of the parallelepiped housing and in that the exit windows are formed on two opposite side walls of the housing.

6. The laser scanning head for marking items according to claim 3, wherein each scanning head comprises a first galvanometric mirror extending in line with the entry window and rigidly secured to an output shaft of a first electric motor, the first galvanometric mirror being adapted to reflect the laser beam passing through the entry window towards a second galvanometric mirror, extending in line with the exit windows and rigidly secured to an output shaft of a second electric motor, the output shaft of the second electric motor being orthogonal to the output shaft of the first electric motor.

7. The laser scanning head for marking items according to claim 3, wherein each scanning head comprises a first galvanometric mirror extending in line with the entry window and rigidly secured to an output shaft of a first electric motor, the first galvanometric mirror being adapted to reflect the laser beam passing through the entry window towards a second galvanometric mirror rigidly secured to the output shaft of a second electric motor, an output shaft of the second electric motor being orthogonal to the output shaft of the first electric motor, the second galvanometric mirror reflecting the laser beam alternately on to a third and a fourth galvanometric mirror extending respectively in line with the exit windows, the third and the fourth galvanometric mirror being rigidly secured to output shafts of a third electric motor and a fourth electric motor, respectively.

8. The laser scanning head for marking items according to claim 7, wherein the output shafts of the second electric motor, of the third electric motor, and of the fourth electric motor extend parallel to one another.

9. The laser scanning head for marking items according to claim 1, wherein each of the exit windows is equipped with a lens.

10. A facility for marking containers, the facility comprising:
at least two conveyors; and
a plurality of marking devices configured to insert information in at least one information region of a container, each marking device being positioned between the two conveyors and configured to alternately insert information in the laser marking region of a first container on a first conveyor then in the information region of a second container on the second conveyor;
wherein the marking devices are configured to emit laser radiation in two opposite directions, the marking devices located in fixed positions equidistant from the two conveyors wherein each marking device comprises:
a laser scanning head for marking items, the scanning head at least comprising a housing, the housing comprising a laser entry window adapted to receive a marking laser beam emitted by a laser source, at least one galvanometric mirror mounted on a rotation shaft of a motor for rotating the galvanometric mirror, and an exit window through which the marking laser beam is emitted towards an item, wherein the housing comprises two opposite exit windows, the scanning head configured to emit two marking laser beams emitted through the exit window from the laser beam emitted by the laser source passing through the entry window.
